(19) United States
(12) Patent Application Publication
(10) Pub. No.: US 2026/0343689 A1
(43) Pub. Date: Oct. 29, 2026

(54) HEAT GENERATING MAT FOR ELECTROMAGNETIC INDUCTION HEATING COOKER

(71) Applicant: Sumitomo Electric Toyama Co., Ltd., Imizu-shi, Toyama (JP)

(72) Inventors: Masatoshi MAJIMA, Imizu-shi, Toyama (JP); Hitoshi TSUCHIDA, Imizu-shi, Toyama (JP)

(73) Assignee: Sumitomo Electric Toyama Co., Ltd., Imizu-shi, Toyama (JP)

(21) Appl. No.: 18/878,950

(22) PCT Filed: Jul. 3, 2024
(86) PCT No.: PCT/JP2024/024067

§ 371 Date: Dec. 26, 2024

(30) Foreign Application Priority Data
Nov. 10, 2023 (JP) 2023-192221

(51) Int. Cl. H05B 6/12

(52) U.S. Cl. CPC H05B 6/1209

(57) ABSTRACT

A heat generating mat for an electromagnetic induction heating cooker includes a sheet-shaped portion including a main body portion consisting of a metal porous body, wherein the metal porous body includes a framework having a three-dimensional mesh structure, and the metal porous body is composed of a magnetic material.

### TECHNICAL FIELD

The present disclosure relates to a heat generating mat for an electromagnetic induction heating cooker. The present application claims priority based on Japanese Patent Application No. 2023-192221 filed on Nov. 10, 2023. The entire contents of the Japanese Patent Application are incorporated herein by reference.

### BACKGROUND ART

An electromagnetic induction heating cooker includes a magnetic force generating coil having a spiral shape, the magnetic force generating coil being located directly below a glass top plate, the magnetic force generating coil being formed by knitting thin copper wires. When current (high-frequency alternating current) is caused to flow through the magnetic force generating coil, strong magnetic lines of force (magnetic field) are generated from the coil, pass through the glass top, and hit the bottom of a pan placed directly thereon. This magnetic field causes generation of eddy current in a metal surface of the bottom of the pan, and the metal of the bottom of the pan becomes resistance for the eddy current, thereby generating heat at the metal surface of the bottom of the pan. Since the electromagnetic induction heating cooker heats the bottom of the pan by using the function of the magnetic lines of force in this way, it is difficult to heat a pan composed of a non-magnetic material or a material having a weak magnetic property.

In recent years, electromagnetic induction heating cookers have been pervasive in general houses, and a technology for using a pan composed of a non-magnetic material or a material having a weak magnetic property on an electromagnetic induction heating cooker has been required while such a pan has been used on a gas cooker.

PTL 1 discloses a conductor for an electromagnetic cooker, the conductor including an iron conductor main body consisting of a net-shaped body. In PTL 1, the iron conductor main body consisting of the net-shaped body is disposed between a cooking container composed of a ceramic and an electromagnetic cooker so as to generate heat from the conductor main body through an electromagnetic induction function, thereby heating the cooking container.

### CITATION LIST

### Patent Literature

PTL 1: Japanese Examined Utility Model Publication No. 1-9112

### SUMMARY OF INVENTION

A heat generating mat for an electromagnetic induction heating cooker according to the present disclosure includes a sheet-shaped portion including a main body portion consisting of a metal porous body, wherein the metal porous body includes a framework having a three-dimensional mesh structure, and the metal porous body is composed of a magnetic material.

### BRIEF DESCRIPTION OF DRAWINGS

FIG. 1 is an enlarged schematic diagram focusing on one of cell portions in a framework having a three-dimensional mesh structure according to a first embodiment.

FIG. 2 is a schematic diagram showing one implementation of a shape of the cell portion.

FIG. 3 is a schematic diagram showing another implementation of the shape of the cell portion.

FIG. 4 is a schematic diagram showing another implementation of the shape of the cell portion.

FIG. 5 is a schematic diagram showing an implementation of two cell portions joined together.

FIG. 6 is a schematic diagram showing an implementation of four cell portions joined together.

FIG. 7 is a schematic diagram showing one implementation of a framework having a three-dimensional mesh structure formed by joining a plurality of cell portions.

FIG. 8 is a diagram illustrating an exemplary heat generating mat for an electromagnetic induction heating cooker according to the first embodiment.

FIG. 9 is a diagram illustrating another exemplary heat generating mat for an electromagnetic induction heating cooker according to the first embodiment.

FIG. 10 is a diagram illustrating another exemplary heat generating mat for an electromagnetic induction heating cooker according to a second embodiment.

FIG. 11 is a diagram illustrating another exemplary heat generating mat for an electromagnetic induction heating cooker according to the second embodiment.

FIG. 12 is a diagram illustrating another exemplary heat generating mat for an electromagnetic induction heating cooker according to the second embodiment.

FIG. 13 is a diagram illustrating another exemplary heat generating mat for an electromagnetic induction heating cooker according to a third embodiment.

FIG. 14 is a diagram illustrating another exemplary heat generating mat for an electromagnetic induction heating cooker according to the third embodiment.

FIG. 15 is a diagram illustrating another exemplary heat generating mat for an electromagnetic induction heating cooker according to the third embodiment.

FIG. 16 is a diagram illustrating another exemplary heat generating mat for an electromagnetic induction heating cooker according to a fourth embodiment.

FIG. 17 is a diagram illustrating another exemplary heat generating mat for an electromagnetic induction heating cooker according to the fourth embodiment.

FIG. 18 is a diagram illustrating another exemplary heat generating mat for an electromagnetic induction heating cooker according to the fourth embodiment.

### DETAILED DESCRIPTION

### Problem to be Solved by the Present Disclosure

Since the iron conductor main body consisting of the net-shaped body is used in the technology of PTL 1, the temperature of the conductor main body is less likely to be decreased even when heating by the electromagnetic cooker is ended. Therefore, in order to remove the conductor for an electromagnetic cooker from the electromagnetic cooker after the end of heating by the electromagnetic induction heating cooker, it is necessary to wait until the conductor for an electromagnetic cooker is cooled, thus resulting in deteriorated efficiency of the cooking. Therefore, there has been required a heat generating element for an electromagnetic induction heating cooker that is facilitated to be cooled after the end of heating by the electromagnetic cooker.

In view of the above, an object of the present disclosure is to provide a heat generating mat for an electromagnetic induction heating cooker that is facilitated to be cooled after end of heating by the electromagnetic induction heating cooker.

### Advantageous Effect of the Present Disclosure

According to the present disclosure, it is possible to provide a heat generating mat for an electromagnetic induction heating cooker that is facilitated to be cooled after end of heating by the electromagnetic induction heating cooker.

### DESCRIPTION OF EMBODIMENTS

First, embodiments of the present disclosure will be listed and described.

(1) A heat generating mat for an electromagnetic induction heating cooker according to the present disclosure includes a sheet-shaped portion including a main body portion consisting of a metal porous body, wherein the metal porous body includes a framework having a three-dimensional mesh structure, and the metal porous body is composed of a magnetic material.

According to the present disclosure, it is possible to provide a heat generating mat for an electromagnetic induction heating cooker that is facilitated to be cooled after end of heating by the electromagnetic induction heating cooker.

(2) In (1), the sheet-shaped portion may include the main body portion and a handle portion protruding outward from an edge portion of the main body portion.

Thus, since the heat generating mat includes the handle portion, the heat generating mat can be readily handled.

(3) In (2), a through hole may be provided in the handle portion. Thus, after the heat generating mat for an electromagnetic induction heating cooker is removed from an electromagnetic cooker, the heat generating mat can be hung on a hook or the like at the through hole for the sake of storage.

(4) In (1) or (2), a through hole may be provided in the main body portion. Thus, the heat generating mat for an electromagnetic induction heating cooker can be readily removed by putting a finger or a cooking tool such as cooking chopsticks, tongs, or a spoon in the through hole of the heat generating mat for an electromagnetic induction heating cooker on the electromagnetic cooker. Moreover, the heat generating mat for an electromagnetic induction heating cooker can be hung on a hook or the like at the through hole for the sake of storage. Moreover, the heat generating mat for an electromagnetic induction heating cooker is further facilitated to be cooled after end of heating by the electromagnetic induction heating cooker.

(5) In (4), the through hole may be provided in a vicinity of an edge portion of the main body portion. Thus, the heat generating mat for an electromagnetic induction heating cooker can be readily removed by putting a finger or a cooking tool such as cooking chopsticks, tongs, or a spoon in the through hole of the heat generating mat for an electromagnetic induction heating cooker on the electromagnetic cooker. Moreover, the heat generating mat for an electromagnetic induction heating cooker can be hung on a hook or the like at the through hole for the sake of storage.

(6) In (4), a shape of an outline of the through hole may be the same as a shape obtained by scaling down an outer shape of the main body portion. Thus, the heat generating mat for an electromagnetic induction heating cooker is further facilitated to be cooled after end of heating by the electromagnetic induction heating cooker.

(7) In any one of (1) to (6), the sheet-shaped portion may include the main body portion and a solid member provided around the main body portion. Thus, strength of the heat generating mat for an electromagnetic induction heating cooker is improved.

(8) In any one of (1) to (7), the magnetic material may include at least one selected from a group consisting of nickel, iron, cobalt, chromium, manganese, molybdenum, and tin. This leads to improved efficiency of induction heating of the heat generating mat for an electromagnetic induction heating cooker by magnetic lines of force.

(9) In any one of (1) to (8), a porosity of the metal porous body may be 90% or more and 98% or less. Thus, the heat generating mat for an electromagnetic induction heating cooker is cooled more quickly after end of heating by the electromagnetic induction heating cooker.

(10) In any one of (1) to (9), a thickness of the main body portion may be 0.5 mm or more and 4 mm or less. Thus, strength of the metal porous body is improved and the metal porous body can have a cushioning property.

### DETAILS OF EMBODIMENTS OF THE PRESENT DISCLOSURE

Specific examples of the heat generating mat for an electromagnetic induction heating cooker according to the present disclosure will be described below with reference to figures. The same reference characters indicate the same or corresponding portions in the figures of the present disclosure. Further, a relation of a dimension such as a length, a width, a thickness, or a depth is modified as appropriate for clarity and brevity of the figures and does not necessarily represent an actual dimensional relation.

In the present specification, the expression “A to B” represents a range of lower to upper limits (i.e., A or more and B or less), and when no unit is indicated for A and a unit is indicated only for B, the unit of A is the same as the unit of B.

When a compound or the like is expressed by a chemical formula in the present specification and an atomic ratio is not particularly limited, it is assumed that all the conventionally known atomic ratios are included, and the atomic ratio should not be necessarily limited only to one in the stoichiometric range.

In the present disclosure, when one or more numerical values are described as each of lower and upper limits of a numerical range, it is assumed that a combination of any one numerical value described as the lower limit and any one numerical value described as the upper limit is also disclosed. For example, when a1 or more, b1 or more, and c1 or more are each described as the lower limit and a2 or less, b2 or less, and c2 or less are each described as the upper limit, it is assumed that a1 or more and a2 or less, a1 or more and b2 or less, a1 or more and c2 or less, b1 or more and a2 or less, b1 or more and b2 or less, b1 or more and c2 or less, c1 or more and a2 or less, c1 or more and b2 or less, and c1 or more and c2 or less are disclosed.

### First Embodiment

A heat generating mat for an electromagnetic induction heating cooker according to one embodiment (hereinafter, also referred to as “first embodiment”) of the present disclosure includes a sheet-shaped portion including a main body portion consisting of a metal porous body, wherein the metal porous body includes a framework having a three-dimensional mesh structure, and the metal porous body is composed of a magnetic material.

The heat generating mat for an electromagnetic induction heating cooker (hereinafter, also referred to as “heat generating mat”) according to the first embodiment includes the sheet-shaped portion including the main body portion consisting of the metal porous body, and the metal porous body is composed of the magnetic material. When the heat generating mat according to the first embodiment is disposed directly on an electromagnetic induction heating cooker (hereinafter, also referred to as “electromagnetic cooker”) and a pan is placed thereon, the sheet-shaped portion generates heat by an electromagnetic induction function, with the result that the pan, which is composed of a non-magnetic material such as aluminum, copper, ceramic, or glass, can be heated. Therefore, even when the pan is composed of a non-magnetic material or a material having a weak magnetic property, the pan can be heated by the electromagnetic cooker by using the heat generating mat according to the first embodiment.

In the heat generating mat according to the first embodiment, the metal porous body constituting the main body portion has the three-dimensional mesh structure, and therefore has a large area exposed to air. Therefore, the heat generating mat is facilitated to be cooled after end of the electromagnetic induction in the electromagnetic cooker or after the heat generating mat is removed from the electromagnetic cooker. Therefore, the heat generating mat is readily handled.

In the heat generating mat according to the first embodiment, the metal porous body constituting the main body portion has the three-dimensional mesh structure, and is therefore light in weight. Therefore, the heat generating mat is readily handled.

In the heat generating mat according to the first embodiment, since the metal porous body constituting the main body portion has the three-dimensional mesh structure, a temperature sensor or infrared sensor of the electromagnetic cooker can detect the temperature of the bottom of the pan, thereby preventing overheating of the pan.

In the heat generating mat according to the first embodiment, since the metal porous body constituting the main body portion has the framework having the three-dimensional mesh structure, the metal porous body is provided with communicating pores. Therefore, the heat generating mat is readily cleaned when the heat generating mat becomes dirty in response to boiling over during cooking.

### <Shape of Heat Generating Mat for Electromagnetic Induction Heating Cooker>

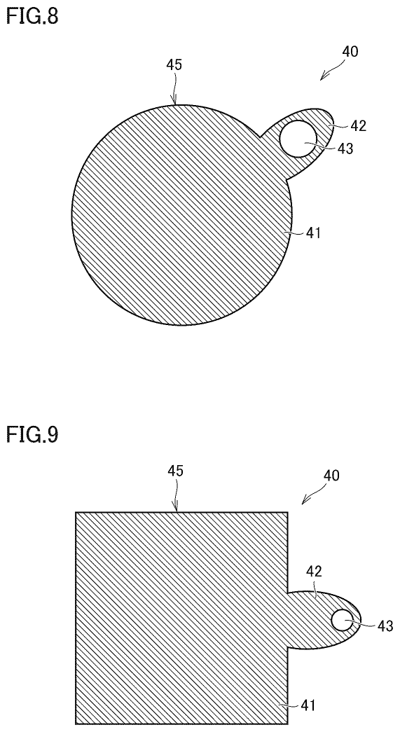

As shown in each of FIGS. 8 and 9, a heat generating mat 40 for an electromagnetic induction heating cooker according to the first embodiment includes a sheet-shaped portion 45 including a main body portion 41 consisting of a metal porous body. Sheet-shaped portion 45 includes main body portion 41 and a handle portion 42 protruding outward from an edge portion of main body portion 41. A through hole 43 may be provided in handle portion 42. In each of FIGS. 8 and 9, sheet-shaped portion 45 consists of the metal porous body.

The shape of main body portion 41 is not particularly limited as long as magnetic lines of force from a magnetic force generating coil having a spiral shape and disposed directly below a glass top plate of the electromagnetic cooker can be received. The shape of main body portion 41 may be, for example, a plate shape with its main surface being in the form of a circle, an ellipse, a rectangle, or a regular polygon such as a square or a regular hexagon.

The size of main body portion 41 is not particularly limited as long as magnetic lines of force from the magnetic force generating coil of the electromagnetic cooker can be received and heat can be transferred to the bottom of a pan when the heat is generated. When the main surface of main body portion 41 is in the form of a circle, the diameter of the circle may be 100 mm or more and 300 mm or less, or may be 150 mm or more and 250 mm or less. When the main surface of main body portion 41 is in the form of an ellipse, the minor axis of the ellipse may be 100 mm or more and 300 mm or less, or may be 150 mm or more and 250 mm or less. When the main surface of main body portion 41 is in the form of a square, the length of each side thereof may be 100 mm or more and 300 mm or less, or may be 150 mm or more and 250 mm or less. When the main surface of main body portion 41 is in the form of a rectangle, the length of each short side thereof may be 100 mm or more and 300 mm or less, or may be 150 mm or more and 250 mm or less. When the main surface of main body portion 41 is in the form of a regular polygon, the length of the diameter of a circle circumscribing the regular polygon may be 100 mm or more and 300 mm or less, or may be 150 mm or more and 250 mm or less.

The shape of handle portion 42 is not particularly limited as long as the heat generating mat can be readily moved and contact between main body portion 41 and the electromagnetic cooker is not hindered.

As shown in each of FIGS. 8 and 9, handle portion 42 can be shaped to protrude outward from the edge portion of main body portion 41. Handle portion 42 may be provided on the same plane as main body portion 41. Further, at least an end portion of handle portion 42 opposite to main body portion 41 may be bent. Thus, handle portion 42 is separated from the electromagnetic cooker when heat generating mat 40 is disposed on the electromagnetic cooker, with the result that heat generating mat 40 for an electromagnetic induction heating cooker can be readily removed from the electromagnetic cooker. One handle portion 42 may be provided, or two or more handle portions 42 may be provided.

The material of handle portion 42 shown in each of FIGS. 8 and 9 can be the same as that of main body portion 41, i.e., the metal porous body. Further, the material of handle portion 42 may be different from the metal porous body. Examples of the material different from the metal porous body include a solid plate material, and a heat-resistant material different from a metal such as a silicone rubber.

As shown in each of FIGS. 8 and 9, through hole 43 may be formed in handle portion 42. Thus, after the heat generating mat for an electromagnetic induction heating cooker is removed from the electromagnetic cooker, the heat generating mat for an electromagnetic induction heating cooker can be hung on a hook or the like at through hole 43 for the sake of storage.

The shape of through hole 43 is not particularly limited as long as it can be hung on a hook or the like. Through hole 43 may be in the form of, for example, a circle, an ellipse, a square, or a rectangle.

The size of through hole 43 is not particularly limited as long as it can be hung on a hook or the like. For example, when through hole 43 is in the form of a circle, the diameter of the circle may be 5 mm or more and 50 mm or less, or may be 10 mm or more and 30 mm or less. When through hole 43 is in the form of an ellipse, the minor axis of the ellipse may be 5 mm or more and 50 mm or less, or may be 10 mm or more and 30 mm or less. When through hole 43 is in the form of a square, the length of each side thereof may be 5 mm or more and 50 mm or less, or may be 10 mm or more and 30 mm or less. When through hole 43 is in the form of a rectangle, the length of each short side thereof may be 5 mm or more and 50 mm or less, or may be 10 mm or more and 30 mm or less.

### <Structure of Metal Porous Body>

In the first embodiment, the metal porous body includes the framework having the three-dimensional mesh structure. In the present disclosure, the three-dimensional mesh structure means a structure in which a constituent solid component is spread three-dimensionally in the form of a mesh. The three-dimensional mesh structure is different from the structure of the net-shaped body described in PTL 1 in which iron wires are knitted two-dimensionally. Here, the solid component is a metal or the like.

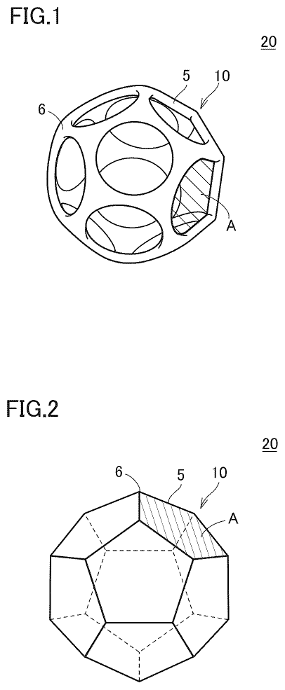

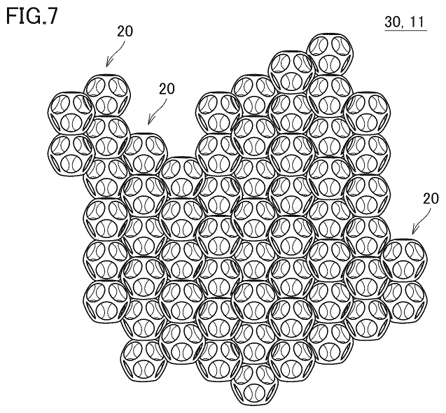

Hereinafter, in order to facilitate understanding of the three-dimensional mesh structure, a constituent unit of the three-dimensional mesh structure will be described as a cell portion 20 for the sake of explanation. FIG. 1 is an enlarged schematic diagram of one cell portion of the three-dimensional mesh structure in the first embodiment. As shown in FIG. 7, three-dimensional mesh structure 30 is formed by joining a plurality of cell portions.

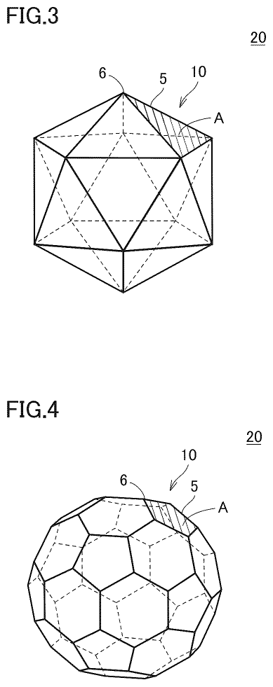

As shown in FIGS. 1 and 2, cell portion 20, which is a constituent unit of the three-dimensional mesh structure, is constituted of a plurality of supporting pillar portions 5 and node portions 6 that connect the plurality of supporting pillar portions 5. Therefore, the framework having the three-dimensional mesh structure can be expressed as being constituted of the plurality of supporting pillar portions 5 and node portions 6 that connect the plurality of supporting pillar portions 5. In the description below, each supporting pillar portion 5 and each node portion 6 will be separately described, but there is no clear boundary therebetween, and the plurality of supporting pillar portions 5 and the plurality of node portions 6 integrally form the framework having the three-dimensional mesh structure. In the description below, in order to facilitate understanding, the shape of the cell portion in FIG. 1 will be assumed as a regular dodecahedron shown in FIG. 2 for the sake of explanation.

The plurality of supporting pillar portions 5 and the plurality of node portions 6 form a frame portion 10, which is a planar polygonal structure. Here, the planar polygon means a polygon when viewed in a plan view. In FIG. 2, the planar polygonal structure is in the form of a regular pentagon, but the shape of the planar polygonal structure is not limited to the regular pentagon. The planar polygonal structure may be in the form of another polygon such as a triangle, a quadrangle, or a hexagon. Frame portion 10 forms planar polygonal holes by the plurality of supporting pillar portions 5 and the plurality of node portions 6.

A plurality of frame portions 10 are combined to form cell portion 20, which is a three-dimensional polyhedral structure. One supporting pillar portion 5 and one node portion 6 are shared by a plurality of frame portions 10. The shape of node portion 6 may be a sharp edge shape having a vertex, a planar shape with a vertex being chamfered, or a curved shape with a vertex being provided with a curvature. In FIG. 2, the three-dimensional polyhedron structure is in the form of a dodecahedron, but may be in the form of another polyhedron such as a cube, an icosahedron (FIG. 3), or a truncated icosahedron (FIG. 4). Cell portion 20 forms a three-dimensional space surrounded by respective imaginary planes A defined by the plurality of frame portions 10.

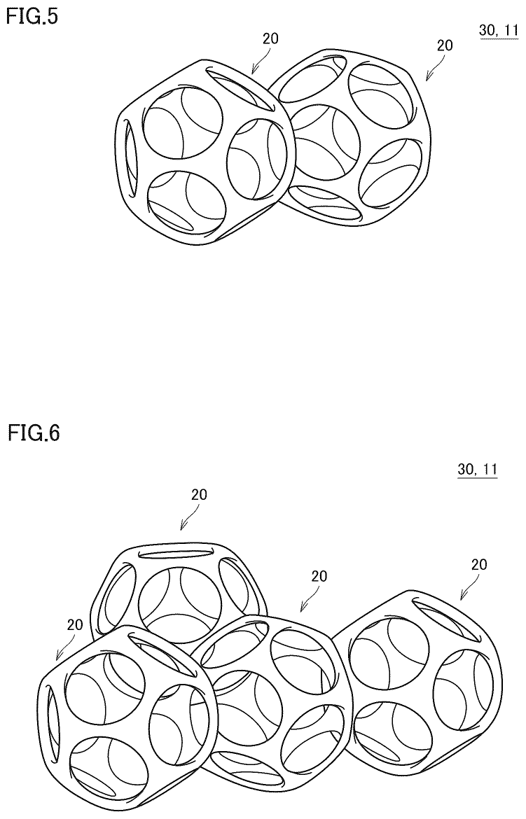

As shown in each of FIGS. 5, 6, and 7, framework 11 having three-dimensional mesh structure 30 is formed by combining a plurality of cell portions 20. A frame portion 10 is shared by a plurality of cell portions 20. A frame portion 10 may be shared by two cell portions 20. Framework 11 having three-dimensional mesh structure 30 can also be expressed as consisting of a plurality of frame portions 10. Framework 11 having three-dimensional mesh structure 30 can also be expressed as consisting of a plurality of cell portions 20. Since the metal porous body of the present disclosure includes framework 11 having three-dimensional mesh structure 30, the metal porous body can be provided with communicating pores.

The metal porous body of the present disclosure is provided with: the planar polygonal holes formed by the frame portions; and the three-dimensional space formed by the cell portions. The metal porous body of the present disclosure can be clearly distinguished from two-dimensional mesh structures such as a punching metal and a grill net each provided with only planar holes. In the framework of the metal porous body of the present disclosure, the plurality of supporting pillar portions and the plurality of node portions integrally form the three-dimensional mesh structure. Therefore, it can be clearly distinguished from a structure such as a nonwoven fabric formed by interlacing fibers each serving as a constituent unit.

The three-dimensional mesh structure of the present disclosure is not limited to the above-described structure. For example, cell portion 20 may be formed by a plurality of frame portions 10 having different sizes and different planar shapes. The three-dimensional mesh structure may be formed by a plurality of cell portions 20 having different sizes and different three-dimensional shapes. The three-dimensional mesh structure may partially include a frame portion 10 in which no planar polygonal hole is formed, or may partially include a cell portion 20 in which no three-dimensional space is formed and which is solid.

### <Composition of Metal Porous Body>

In the first embodiment, the metal porous body is composed of the magnetic material. The magnetic material may include at least one selected from a group consisting of nickel, iron, cobalt, chromium, manganese, molybdenum, and tin. The magnetic material can consist of at least one selected from a group consisting of nickel, a nickel-iron alloy (for example, permalloy having a nickel content ratio of 78.5%), a nickel-cobalt alloy, a nickel-iron-chromium alloy, a nickel-iron-manganese alloy, a nickel-iron-molybdenum alloy, a nickel-tin alloy, cobalt, a cobalt-chromium alloy, a cobalt-tin alloy, a cobalt-iron alloy, and a material including at least one of them and copper.

The metal porous body may include an impurity other than the magnetic material as long as the effects of the present disclosure are not impaired. The metal porous body can be composed of the magnetic material and at least one impurity selected from a group consisting of carbon, phosphorus, sulfur, oxygen, and chlorine. The content ratio of the impurity in the framework can be 1% or less.

The composition of the metal porous body is specified in the following procedure. The metal porous body is embedded in a resin and a polishing machine and a cross section polisher are then used to perform surface processing, thereby exposing a cross section of the framework. The cross section of the framework is subjected to a surface analysis using a SEM-EDX so as to specify the composition of the metal porous body. A condition of the SEM-EDX is an acceleration voltage of 15 keV.

### <Porosity of Metal Porous Body>

The porosity of the metal porous body may be 90% or more and 98% or less, may be 92% or more and 97% or less, or may be 94% or more and 96% or less. Since the porosity of the metal porous body is 90% or more, the surface area of the metal porous body is large, thus resulting in a larger area exposed to air. Therefore, the metal porous body is further facilitated to be cooled after electromagnetic induction in the electromagnetic cooker is ended or after removed from the electromagnetic cooker. Moreover, the metal porous body can be very light in weight. Since the porosity of the metal porous body is 98% or less, strength of the metal porous body can be sufficient.

In the present disclosure, the porosity of the metal porous body is defined by the following formula.

Porosity [%]=(the volume [cm³] of the pores of the metal porous body/the volume [cm³] of the metal porous body)×100

In the above-described formula, the volume of the metal porous body means the volume of the shape of the appearance of the metal porous body.

A method of measuring each of the volume of the pores of the metal porous body and the volume of the metal porous body is as follows. Three-dimensional data of the metal porous body is acquired by X-ray CT, and each of the volume of the pores of the metal porous body and the volume of the metal porous body is found based on the three-dimensional data. The volume of a whole of a measurement region in the X-ray CT corresponds to the volume of the metal porous body in the above-described formula. The size of the measurement region in the X-ray CT is 2 mm³ or more. The size of the measurement region can be appropriately set in accordance with the size of a measurement target.

The porosity of the metal porous body is calculated by substituting the obtained volume of the pores of the metal porous body and the obtained volume of the metal porous body into the above-described formula. For the metal porous body serving as one measurement target, three measurement regions that do not overlap with one another are set. In each of the three measurement regions, the volume of the pores of the metal porous body and the volume of the metal porous body are found, and the porosity of the metal porous body is calculated. The average of the porosities of the metal porous body in the three measurement regions is calculated. In the present disclosure, the average of the porosities of the metal porous body in the three measurement regions corresponds to the porosity of the metal porous body.

### <Average Pore Diameter of Metal Porous Body>

The average pore diameter of the metal porous body may be 250 μm or more and 3500 μm or less, may be 250 μm or more and 1000 μm or less, or may be 250 μm or more and 850 μm or less. The pore diameter of the metal porous body means the pore diameter of the three-dimensional space defined by the outer surface of the framework. Since the average pore diameter of the metal porous body is 250 μm or more, bendability of the metal porous body can be increased. Since the average pore diameter of the metal porous body is 3500 μm or less, the strength of the metal porous body can be increased.

A method of measuring the average pore diameter of the metal porous body is as follows. Three-dimensional data of the metal porous body is acquired by X-ray CT. The size of a measurement region in the X-ray CT is 2 mm³ or more. The size of the measurement region can be appropriately set in accordance with the size of a measurement target. Based on the three-dimensional data, all the pore diameters of the metal porous body in the measurement region are found. Here, the pore diameter of the metal porous body means the equivalent volume diameter of each pore. When a part of a pore is located outside the measurement region, the pore is excluded from the measurement. The average (hereinafter, also referred to as “first average pore diameter”) of the pore diameters of all the pores in the measurement region is calculated.

The above-described measurement is performed in any three measurement regions set in the metal porous body. The first average pore diameter is calculated in each of the three measurement regions, and the average thereof is calculated. In the present disclosure, the average of the three first average pore diameters corresponds to the average pore diameter of the metal porous body.

It has been confirmed that as long as the measurement is performed for the same metal porous body, there is substantially no variation in measurement results even when the measurement is performed a plurality of times with the positions of the three measurement regions being selected freely.

### <Thickness of Main Body Portion>

The thickness of main body portion 41 according to the first embodiment may be 0.5 mm or more and 4 mm or less, may be 0.8 mm or more and 2 mm or less, or may be 1 mm or more and 1.6 mm or less. Since the thickness of main body portion 41 is 0.5 mm or more, the strength of main body portion 41 is improved, and main body portion 41 can have a cushioning property. Since the thickness of main body portion 41 is 4 mm or less, the bendability of main body portion 41 can be increased.

The thickness of main body portion 41 is measured by a digital thickness gauge. The measurement of the thickness is performed at three locations freely set in a region at a distance of 2 mm or more from the outer edge of main body portion 41. The average of the thicknesses thereof at the three locations is calculated. In the present disclosure, the average of the thicknesses thereof at the three locations corresponds to the thickness of main body portion 41.

### Second Embodiment

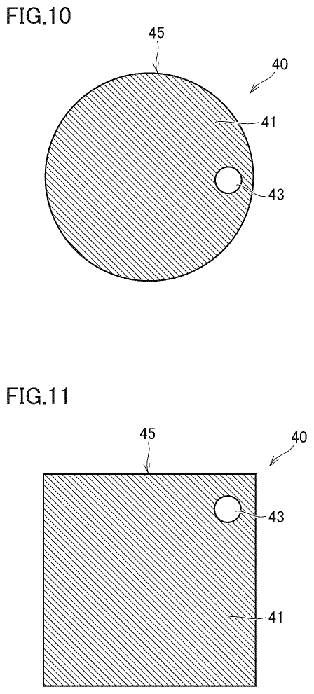

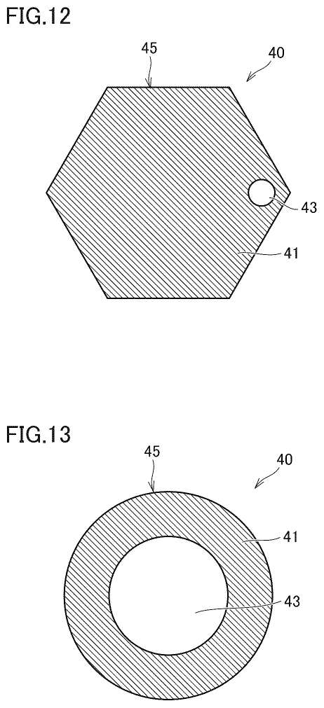

A heat generating mat for an electromagnetic induction heating cooker according to one embodiment (hereinafter, also referred to as “second embodiment”) of the present disclosure will be described with reference to FIGS. 10 to 12. The heat generating mat according to the second embodiment can have the same configuration as that of the first embodiment except that a through hole is provided in the main body portion. The following describes the difference from the first embodiment.

As shown in each of FIGS. 10 to 12, in heat generating mat 40 for an electromagnetic induction heating cooker according to the second embodiment, a sheet-shaped portion 45 includes a main body portion 41 provided with a through hole 43. Through hole 43 is provided in the vicinity of an edge portion of main body portion 41. Heat generating mat 40 for an electromagnetic induction heating cooker can be readily removed by putting a finger or a cooking tool such as cocking chopsticks, tongs, or a spoon in through hole 43 of heat generating mat 40 for an electromagnetic induction heating cooker on the electromagnetic cooker. Moreover, heat generating mat 40 for an electromagnetic induction heating cooker can be hung on a hook or the like at through hole 43 for the sake of storage.

The shape of through hole 43 is not particularly limited as long as a finger or a cooking tool can be put therein. Through hole 43 can be in the form of, for example, a circle, an ellipse, a square, or a rectangle.

The size of through hole 43 is not particularly limited as long as a finger or a cooking tool can be put therein. The size of through hole 43 can be the same as the size of through hole 43 formed in handle portion 42 of the heat generating mat according to the first embodiment.

The minimum value of a distance between the outer edge of main body portion 41 and the outer edge of through hole 43 may be 5 mm or more and 50 mm or less. Thus, strength of main body portion 41 between the outer edge of main body portion 41 and through hole 43 can be maintained.

### Third Embodiment

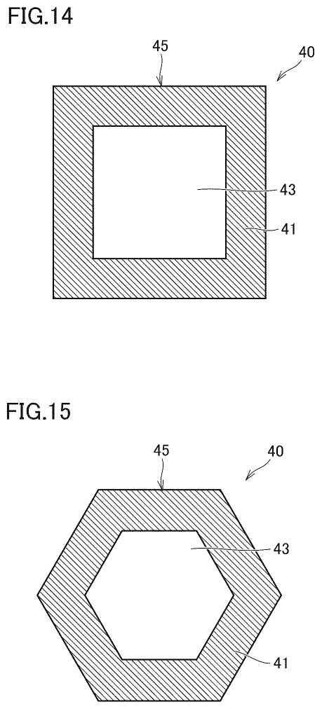

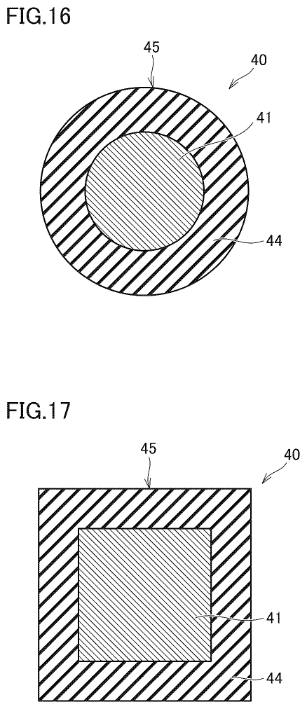

A heat generating mat for an electromagnetic induction heating cooker according to one embodiment (hereinafter, also referred to as “third embodiment”) of the present disclosure will be described with reference to FIGS. 13 to 15. The heat generating mat according to the third embodiment can have the same configuration as that of the first embodiment except that a through hole is provided in the main body portion. The following describes the difference from the first embodiment.

As shown in each of FIGS. 13 to 15, in heat generating mat 40 for an electromagnetic induction heating cooker according to the third embodiment, a sheet-shaped portion 45 includes a main body portion 41 provided with a through hole 43. The shape of the outline of through hole 43 is the same as a shape obtained by scaling down the outer shape of main body portion 41. Thus, heat generating mat 40 for an electromagnetic induction heating cooker is further facilitated to be cooled after end of heating by the electromagnetic induction heating cooker.

The minimum value of a distance between the outer edge of main body portion 41 and the outer edge of through hole 43 may be 5 mm or more and 50 mm or less. Thus, strength of the heat generating mat for an electromagnetic induction heating cooker can be maintained.

Heat generating mat 40 for an electromagnetic induction heating cooker in each of FIGS. 13 to 15 includes no handle portion, but heat generating mat 40 for an electromagnetic induction heating cooker according to the third embodiment may include a handle portion protruding outward from an edge portion of the main body portion.

### Fourth Embodiment

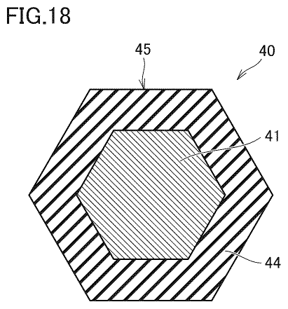

A heat generating mat for an electromagnetic induction heating cooker according to one embodiment (hereinafter, also referred to as “fourth embodiment”) of the present disclosure will be described with reference to FIGS. 16 to 18. Heat generating mat 40 for an electromagnetic induction heating cooker according to the fourth embodiment can have the same configuration as that of the first embodiment except that a sheet-shaped portion 45 includes a main body portion 41 and a solid member 44 provided around main body portion 41.

As shown in each of FIGS. 16 to 18, in the heat generating mat according to the fourth embodiment, sheet-shaped portion 45 includes main body portion 41 and solid member 44 provided around main body portion 41. Thus, strength of heat generating mat 40 for an electromagnetic induction heating cooker is improved.

Solid member 44 can be composed of a solid plate material or a heat-resistant material different from a metal such as a silicone rubber.

In heat generating mat 40 for an electromagnetic induction heating cooker shown in each of FIGS. 16 to 18, no through hole is formed in main body portion 41, but through hole(s) may be formed in one or both of main body portion 41 and solid member 44 of the heat generating mat.

In the heat generating mat according to the fourth embodiment, a through hole may be formed in the vicinity of an edge portion of solid member 44. Thus, the heat generating mat for an electromagnetic induction heating cooker can be hung on a hook or the like at through hole 43 for the sake of storage after the heat generating mat for an electromagnetic induction heating cooker is removed from the electromagnetic cooker.

In the heat generating mat according to the fourth embodiment, a through hole may be formed in main body portion 41, and the shape of the outline of the through hole may be the same as a shape obtained by scaling down the outer shape of main body portion 41. Thus, the heat generating mat for an electromagnetic induction heating cooker is further facilitated to be cooled after end of heating by the electromagnetic induction heating cooker.

Heat generating mat 40 for an electromagnetic induction heating cooker in each of FIGS. 16 to 18 includes no handle portion, but heat generating mat 40 for an electromagnetic induction heating cooker according to the fourth embodiment may include a handle portion protruding outward from an edge portion of the solid member.

### Examples

The present embodiment will be described more specifically with reference to examples. It should be noted that the present embodiment is not limited by these examples.

### [Production of Heat Generating Mat for Electromagnetic Induction Heating Cooker]

For each sample, a heat generating mat for an electromagnetic induction heating cooker was produced to have the shape shown in FIG. 8. A main body portion of each of samples 1 to 7 consists of the metal porous body having the framework having the three-dimensional mesh structure. A main body portion of each of samples 1-1 to 1-7 consists of a metal net-shaped body. The metal net-shaped body is formed by knitting metal wires two-dimensionally.

In each of all the samples, the diameter of the main body portion is 150 mm. The composition and porosity of the metal porous body or metal net-shaped body and the thickness of the main body portion in each sample are shown in the column “Composition”, “Porosity” and “Thickness” in Table 1. It should be noted that the porosity of the metal net-shaped body is calculated by the following formula: porosity [%]=[1−(the volume [cm³] of the metal wires/the volume of the shape of the appearance [cm³] of the metal net-shaped body)]×100.

### [Evaluation]

The heat generating mat for a heating cooker in each of the samples was heated using an electromagnetic induction heating cooker, and the heating by the electromagnetic induction heating cooker was stopped when the temperature reached 230 °C. The heat generating mat for a heating cooker was left on the electromagnetic induction heating cooker, and a time until the temperature reached 50 °C was measured. Results are shown in the column “Cooling Time” in Table 1.

TABLE 1

| | Main Body Portion | | | | Cooling |
|---|---|---|---|---|---|
| Sample | | | Porosity | Thickness | Time |
| No. | Structure | Composition | % | mm | Minute |
| 1 | Metal Porous | Ni | 98 | 1.2 | 0.1 |
| | Body | | | | |
| 2 | Metal Porous | Ni | 90 | 1.2 | 0.3 |
| | Body | | | | |
| 3 | Metal Porous | Ni | 95 | 1.2 | 0.2 |
| | Body | | | | |
| 4 | Metal Porous | Ni | 95 | 3.0 | 0.25 |
| | Body | | | | |
| 5 | Metal Porous | NiCo | 95 | 1.2 | 0.3 |
| | Body | | | | |
| 6 | Metal Porous | NiFe (Permalloy) | 95 | 1.2 | 0.4 |
| | Body | | | | |
| 7 | Metal Porous | Ni-Fe-Mo | 95 | 1.2 | 0.5 |
| | Body | | | | |
| 1-1 | Metal Net- | Ni | 80 | 1.2 | 1 |
| | Shaped Body | | | | |
| 1-2 | Metal Net- | Ni | 20 | 1.2 | 3 |
| | Shaped Body | | | | |
| 1-3 | Metal Net- | Ni | 40 | 1.2 | 2 |
| | Shaped Body | | | | |
| 1-4 | Metal Net- | Ni | 20 | 3.0 | 5 |
| | Shaped Body | | | | |
| 1-5 | Metal Net- | NiCo | 20 | 1.2 | 4 |
| | Shaped Body | | | | |
| 1-6 | Metal Net- | NiFe (Permalloy) | 20 | 1.2 | 5 |
| | Shaped Body | | | | |
| 1-7 | Metal Net- | Ni-Fe-Mo | 20 | 1.2 | 6 |
| | Shaped Body | | | | |

### [Review]

The heat generating mat for an electromagnetic induction heating cooker in each of samples 1 to 7 corresponds to an example of the present disclosure. The heat generating mat for an electromagnetic induction heating cooker in each of samples 1-1 to 1-7 corresponds to a comparative example. It was confirmed that the heat generating mat for an electromagnetic induction heating cooker in each of samples 1 to 7 is facilitated to be cooled after end of heating by the electromagnetic induction heating cooker, as compared with the heat generating mat for an electromagnetic induction heating cooker in each of samples 1-1 to 1-7.

Although the embodiments and examples of the present disclosure have been described as described above, it is also initially expected to appropriately combine or variously modify the configurations of the above-described embodiments and examples.

The embodiments and examples disclosed herein are illustrative and non-restrictive in any respect. The scope of the present invention is defined by the terms of the claims, rather than the embodiments and examples described above, and is intended to include any modifications within the scope and meaning equivalent to the terms of the claims.

### REFERENCE SIGNS LIST

1 metal porous body; 5 supporting pillar portion; 6 node portion; 10 frame portion; 11 framework; 20 cell portion; 30 three-dimensional mesh structure; 40 heat generating mat for an electromagnetic induction heating cooker; 41 main body portion; 42 handle portion; 43 through hole; 44 solid member; 45 sheet-shaped portion.

1. A heat generating mat for an electromagnetic induction heating cooker, the heat generating mat comprising a sheet-shaped portion including a main body portion consisting of a metal porous body, wherein
the metal porous body includes a framework having a three-dimensional mesh structure, and
the metal porous body is composed of a magnetic material.

2. The heat generating mat for an electromagnetic induction heating cooker according to claim 1, wherein the sheet-shaped portion includes the main body portion and a handle portion protruding outward from an edge portion of the main body portion.

3. The heat generating mat for an electromagnetic induction heating cooker according to claim 2, wherein a through hole is provided in the handle portion.

4. The heat generating mat for an electromagnetic induction heating cooker according to claim 1, wherein a through hole is provided in the main body portion.

5. The heat generating mat for an electromagnetic induction heating cooker according to claim 4, wherein the through hole is provided in a vicinity of an edge portion of the main body portion.

6. The heat generating mat for an electromagnetic induction heating cooker according to claim 4, wherein a shape of an outline of the through hole is the same as a shape obtained by scaling down an outer shape of the main body portion.

7. The heat generating mat for an electromagnetic induction heating cooker according to claim 1, wherein the sheet-shaped portion includes the main body portion and a solid member provided around the main body portion.

8. The heat generating mat for an electromagnetic induction heating cooker according to claim 1, wherein the magnetic material includes at least one selected from a group consisting of nickel, iron, cobalt, chromium, manganese, molybdenum, and tin.

9. The heat generating mat for an electromagnetic induction heating cooker according to claim 1, wherein a porosity of the metal porous body is 90% or more and 98% or less.

10. The heat generating mat for an electromagnetic induction heating cooker according to claim 1, wherein a thickness of the main body portion is 0.5 mm or more and 4 mm or less.
